(19) United States
(12) Patent Application Publication
(10) Pub. No.: US 2009/0285614 A1
(43) Pub. Date: Nov. 19, 2009

(54) IMAGE FORMING APPARATUS

(75) Inventor: Satoshi HAMAYA, Tokyo (JP)

Correspondence Address: CANTOR COLBURN, LLP, 20 Church Street, 22nd Floor, Hartford, CT, 06103, US

(73) Assignee: Konica Minolta Business Technologies, Inc., Tokyo (JP)

(21) Appl. No.: 12/463,227

(22) Filed: May 8, 2009

(30) Foreign Application Priority Data
May 13, 2008 (JP) 2008-125796

(51) Int. Cl. G03G 15/00

(52) U.S. Cl. 399/401; 399/405; 399/406

(57) ABSTRACT

By providing a rib formed to be inclined with respect to the conveyance direction on a guide member provided at the upstream side of the conveyance section where a contact member that cools rapidly the sheet subjected to fixing processing is provided, a problem of the occurrence of uneven gloss on the surface of a toner image by contact between a sheet and a guide member or a conveyance roller in a conveyance section that conveys the sheet subjected to fixing processing is solved.

This application is based on Japanese Patent Application No. 2008-125796 filed on May 13, 2008 in Japanese Patent Office, the entire content of which is hereby incorporated by reference.

### BACKGROUND OF THE INVENTION

The present invention relates to an image forming apparatus of an electrophotographic type, and in particular, to an improvement of a conveyance section that conveys a sheet which has been processed in terms of fixing.

In the image forming apparatus of an electrophotographic type, a toner image is fixed on a sheet through heating and pressurization.

In recent years, a demand for higher image quality and more colored images has brought a tendency wherein toner contains wax and further the wax content is increasing. Wax is contained in toner for the purposes to prevent an offset, to improve a separating function of a sheet to separate from a fixing roller and to adjust glossiness of a toner image.

When wax touches constituent parts of a conveyance section in the downstream side of a fixing unit, a surface condition of a toner image becomes uneven and it brings uneven gloss, because wax is not solidified immediately after fixing processing, thus, the image quality is sometimes lowered.

To avoid such a decline of the image quality, a spur roller whose tip is formed in a shape of a needle is provided on a conveyance section after fixing processing to guide a toner image carrying surface of a sheet, in Unexamined Japanese Patent Application Publication No. 2005-234170.

Since an area of contact between the spur roller and a sheet is very small, a decline of quality of a toner image can be prevented effectively.

However, there are problems that it is difficult to provide the spur roller in a conveyance section where a conveyance route is complicated, and a place where the spur roller can be provided is only a part of the conveyance section after fixing.

There is a further problem that the spur roller is expensive and causes cost increase.

### SUMMARY

An objective of the invention is to solve the aforesaid problems of the prior art, to be applied to a conveyance section having a complicated conveyance path, and to offer an image forming apparatus whose cost increase is less and the decline of whose image quality is prevented.

The objectives mentioned above can be attained by embodiments of the invention including the following.

An image forming apparatus including an image forming section which forms a toner image on a sheet, a fixing unit which heats and fixes the toner image on the sheet, and a conveyance section which conveys the sheet which has passed through the fixing unit, wherein the conveyance section includes a contact member which touches the sheet, and a guide member which is positioned upstream of the contact member in the sheet conveyance direction and which guides the sheet being conveyed, wherein the guide member includes ribs which are inclined with respect to the sheet conveyance direction.

### BRIEF DESCRIPTION OF THE DRAWINGS

FIG. 1 is a diagram showing the overall structure of a color image forming apparatus representing an image forming apparatus relating to the embodiment of the invention.

FIG. 2 is a cross-sectional view of a conveyance section that conveys a sheet that has been subjected to fixing processing.

FIG. 3 is a diagram showing a part of the conveyance section shown in FIG. 2.

### DETAILED DESCRIPTION OF THE PREFERRED EMBODIMENTS

The invention will be described as follows, referring to embodiments of the invention, to which, however, the invention is not limited.

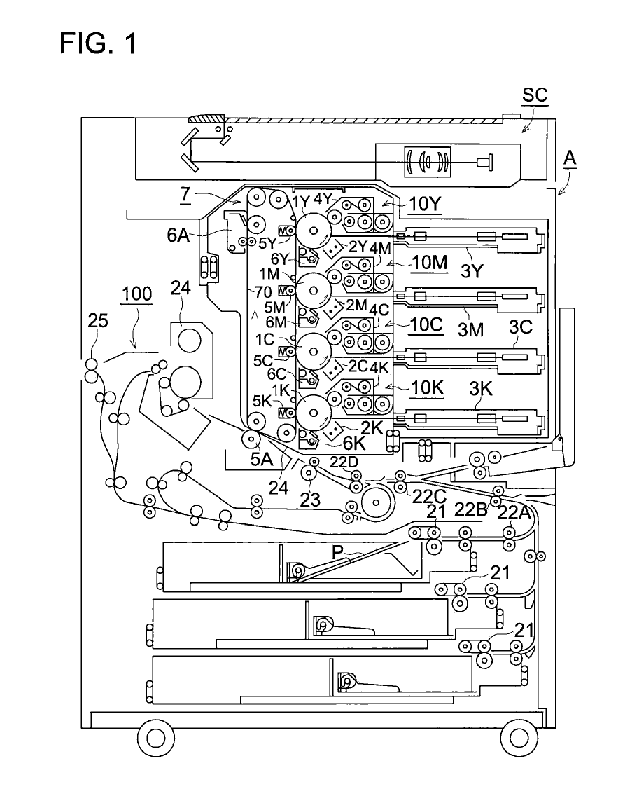

FIG. 1 is a diagram showing the overall structure of a color image forming apparatus representing an image forming apparatus relating to an embodiment of the invention.

The color image forming apparatus is called a color image forming apparatus of a tandem type in which a scanning optical device is used as an exposure device, and toner images each being formed on a photoconductor are transferred onto an intermediate transfer body to be superposed, and then the toner images thus superposed are transferred collectively onto sheet P. The image forming apparatus is equipped with plural sets of image forming units 10Y, 10M, 10C and 10K, intermediate transfer unit 7, sheet feeding conveyance device and with fixing unit 24. On the upper portion of image forming apparatus main body A, original document reading device SC is arranged.

Plural sets of image forming units 10Y, 10M, 10C and 10K and intermediate transfer unit 7 constitute an image forming section that forms a toner image on sheet P.

Image forming unit 10Y that forms a yellow toner image has therein charging device 2Y, exposure device 3Y, developing device 4Y, primary transfer device 5Y and cleaning device 6Y which are arranged on a circumference of photoconductor 1Y. Image forming unit 10M that forms a magenta toner image has therein photoconductor 1M, charging device 2M, exposure device 3M, developing device 4M, primary transfer device 5M and cleaning device 6M. Image forming unit 10C that forms a cyan toner image has therein photoconductor 1C, charging device 2C, exposure device 3C, developing device 4C, primary transfer device 5C and cleaning device 6C. Image forming unit 10K that forms a black toner image has therein photoconductor 1K, charging device 2K, exposure device 3K, developing device 4K, primary transfer device 5K and cleaning device 6K. In each image forming unit 10, charging, exposure and development are carried out, and a toner image of each color is formed on photoconductor 1.

Intermediate transfer unit 7 has intermediate transfer body 70 in a form of a semiconductive endless belt that is wound around plural rollers to be supported rotatably.

Toner images each having each color formed by image forming units 10Y, 10M, 10C and 10K are transferred onto the rotating intermediate transfer body 70 by primary transfer device 5Y, 5M, 5C and 5K to be superposed in synchronization successively, whereby, a composite color toner image is formed on the intermediate transfer body 70. Sheet P loaded in sheet feeding cassette 20 is fed by sheet feeding device 21. The sheet P thus fed is conveyed to secondary transfer device 5A through plural intermediate rollers 22A, 22B, 22C and 22D as well as registration roller 23. In the secondary transfer device SA, color toner images superposed on sheet P are transferred collectively. The sheet P onto which a color toner image is transferred is subjected to fixing processing by fixing unit 24, and then, is ejected out of an apparatus by sheet ejection roller 25.

The sheet P that has passed through the fixing unit 24 and has been subjected to fixing processing is ejected with its image carrying surface facing upward or is ejected with its image carrying surface facing downward or it is fed again to the image forming section for forming of images on the back side under the control of conveyance section 100.

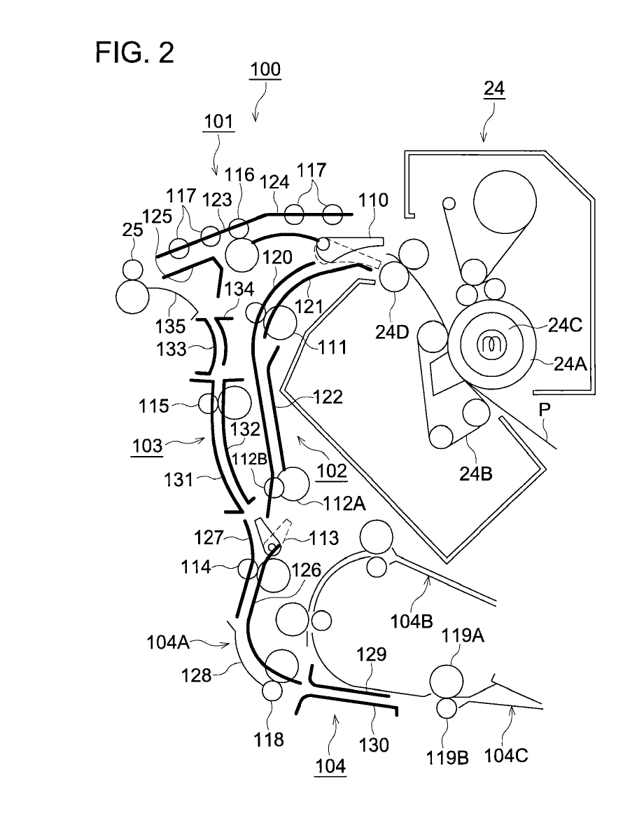

With respect to the conveyance section, it will be described later by using FIG. 2 and thereafter.

On the other hand, after the color toner image is transferred onto sheet P by secondary transfer device SA, remaining toner is removed by cleaning device 6A on intermediate transfer body 70 from which the sheet P is separated using a curvature.

In the course of image forming processing, primary transfer device 5K is in contact with photoconductor 1K with pressure constantly. Other primary transfer devices 5Y, 5M and 5C come in contact with their corresponding photoconductors 1Y, 1M and 1C with pressure only when forming color images.

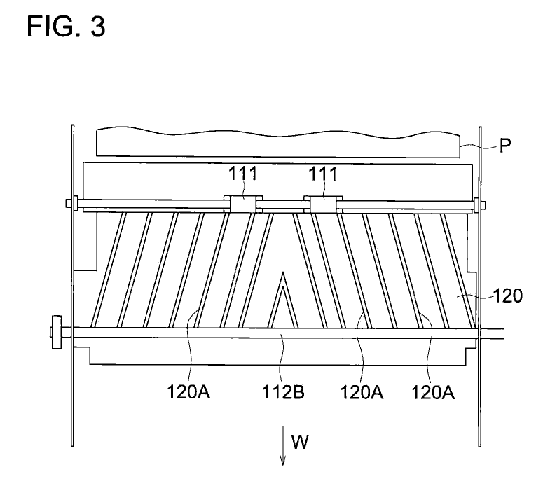

A conveyance section that conveys sheet P which has passed through fixing unit 24 will be described as follows, referring to FIGS. 2 and 3. FIG. 2 is a cross-sectional view of a conveyance section that conveys a sheet that has been subjected to fixing processing, and FIG. 3 is a diagram showing a part of the conveyance section shown in FIG. 2.

Conveyance section 100 has therein straight sheet ejecting section 101, branched conveyance section 102, reversed sheet ejecting section 103 and sheet refeeding section 104 which are arranged at the downstream side of fixing unit 24.

The fixing unit 24 is a belt fixing unit wherein a sheet is nipped between fixing roller 24A having heater 24C built-in and fixing belt 24B to be conveyed while fixing.

In a face-up sheet ejection mode wherein sheet P having passed through fixing unit 24 is ejected from an image forming apparatus without being reversed, straight sheet ejecting section 101 is used. In a face-down sheet ejection mode wherein sheet P having passed through fixing unit 24 is ejected after being reversed upside down, a sheet is conveyed from branched conveyance section 102 to sheet refeeding section 104, and when the trailing edge of the sheet has passed through the branched conveyance section 102, the direction of conveyance is reversed to convey the sheet to reversed sheet ejecting section 103. Then, sheet P is ejected from the reversed sheet ejecting section 103 to the outside of the image forming apparatus through sheet ejection roller 25.

In the case of two-sided image forming, sheet P having a toner image formed on the front surface and having passed through fixing unit 24 is conveyed from branched conveyance section 102 to sheet refeeding section 104 where the sheet P is reversed upside down to be fed again to the image forming section.

The switching of the conveyance path described above is carried out by switching gate 110 arranged at the immediate downstream side of fixing unit 24 and switching gate 113 arranged between branched conveyance section 102, reversed sheet ejecting section 103 and sheet refeeding section 104, between a position indicated with solid lines and a position indicated with dotted lines both shown in FIG. 2.

Straight sheet ejecting section 101 has therein paired conveyance rollers 116, plate-shaped guide members 123, 124 and 125 and spur roller 117.

Meanwhile, in the following description, a toner image carrying surface of a sheet means a surface of the sheet that carries a toner image immediately after fixing processing.

In the straight sheet ejecting section 101, sheet P that has been subjected to fixing processing and carries a toner image on its upper surface is conveyed. Therefore, in the normal conveyance, sheet P is conveyed by guide of spur roller 117 without touching guide member 123, thus, sticking of the sheet and uneven gloss of a toner image are prevented.

Branched conveyance section 102 has therein paired conveyance rollers 111 and 112 as well as plate-shaped guide members 120, 121 and 122.

The paired conveyance rollers 111 composed of a drive roller with a large diameter and a driven roller with a small diameter.

Each of paired conveyance rollers 112 is a roller for correcting a curl of sheet P, and it is composed of rubber roller 112A having a large diameter that is uniform for the total width of sheet P and of metal roller 112B that is made of stainless steel and has a small diameter that is uniform for the total width of sheet P.

Metal roller 112B representing a contact member that touches sheet P is pressing itself into rubber roller 112A as shown in FIG. 2. Accordingly, when the sheet P passes through paired conveyance rollers 112, the sheet P is deformed to follow the outer diameter of the metal roller 112B, thereby, a curl of the sheet P is corrected.

Guide members 120, 121 and 122 are made of resin.

The guide member 120 guides the toner image carrying surface of sheet P.

As shown in FIG. 3, the guide member 120 has many ribs 120A on its guide surface.

As shown in FIG. 3, ribs 120A are formed to be inclined with respect to conveyance direction W for sheet P. Incidentally, the ribs 120A have only to be inclined with respect to the conveyance direction W, and they are formed to be in linear or curved lines. The ribs 120A are inclined to be symmetrical about a central line of a conveyance path as illustrated. Owing to this, sheet P can be conveyed without yawing in terms of the conveyance direction.

Reversed sheet ejecting section 103 has paired conveyance rollers 115 and plate-shaped guide members 131-135.

The paired conveyance rollers 115 are composed of a drive roller with a large diameter and a driven roller with a small diameter.

The guide members 131-134 are made of resin, and guide member 135 serving as a contact member is made of metal. Each of guide members 131 and 133 that guides an image carrying surface of sheet P in the case of reversed sheet ejecting has ribs inclined with respect to the conveyance direction for the sheet, in the same way as guide member 120.

Sheet refeeding section 104 is composed of sheet refeeding introduction path 104A, sheet refeeding path 104B and reversing path 104C.

Sheet P conveyed from branched conveyance section 102 is conveyed from sheet refeeding introduction path 104A to the reversing path 104C.

In the reversed sheet ejecting for reversing sheet P upside down, sheet P conveyed to sheet refeeding introduction path 104A and the reversing path 104C is reversed in terms of its direction to be conveyed, and is ejected to the outside of an image forming apparatus through reversed sheet ejecting section 103.

In the case of forming an image on a reverse side, sheet P having a toner image on its front surface is conveyed to the reversing path 104C through branched conveyance section 102, and when its trailing edge has passed the sheet refeeding introduction path 104A, the sheet P is reversed in terms of its conveyance direction to be conveyed to the sheet refeeding path 104B.

With a reversal of the conveyance direction at the reversing path 104C, the sheet P reversed upside down is fed again from the sheet refeeding path 104B to the image forming section.

The sheet refeeding introduction path 104A has therein paired conveyance rollers 114 and 118 as well as plate-shaped guide members 126-130.

The guide members 126, 127, 129 and 130 are made of resin, and guide member 128 serving as a contact member is made of metal.

The reversing path 104C has many paired conveyance rollers and guide members, and paired conveyance rollers 119 arranged at the entrance of the reversing path 104C are composed of a rubber drive roller 119A with a large diameter and of metal driven roller 119B with a small diameter (contact member).

Each of guide members 127 and 130 has ribs inclined with respect to the conveyance direction for the sheet, in the same way as guide member 120.

Guidance for a sheet by a guide member having a rib inclined with respect to the conveyance direction for sheet P will be described as follows, referring to the example of guide member 120.

A wax component that is a constituent component of toner oozes from the toner image on the sheet P subjected to fixing processing in fixing unit 24 due to heating and forms a surface layer.

Immediately after fixing, this surface layer has not been solidified sufficiently, and it is in molten state or in semi-molten state, however it is cooled to be solidified as time advances.

Therefore, if a toner image touches a guide member or the like immediately after fixing, heat is drawn from the toner image, resulting in great decline of temperature on the contact portion, and unevenness of temperature distribution on the surface of sheet P is caused.

Rapid cooling of sheet P having such uneven temperature distribution leads to unevenness in surface state of sheet P.

That is to say, on the low temperature portion, crystallization of wax advances and glossiness is enhanced. As a result, uneven gloss is formed on the surface of the toner image.

The problem of the uneven gloss of this kind is caused when a toner image is formed by toner containing wax.

In other words, toner contains wax in 1-15 mass %, and when a toner image is formed with this kind of toner, the uneven gloss tends to be caused.

In conveyance section 100 behind the fixing unit, a toner image has not been solidified yet as described earlier, therefore, the toner image is adhesive and has a tendency to stick to a guide plate. To prevent this, ribs for preventing the sticking are formed on the guide member provided on the conveyance path existing at immediate downstream side of the fixing unit.

In the past, these ribs were formed to be in parallel with the conveyance direction, which resulted in uneven temperature distribution on the sheet P, because of creation of a portion of sheet P that touches the ribs and is lowered in terms of temperature and a portion that touches no ribs and is kept to be at high temperature.

When contact members such as paired conveyance rollers and guide members which cool sheet P rapidly are provided at the downstream side of the guide member on which the ribs are formed, the aforesaid uneven gloss on the surface of sheet P appears in the form of a streak by rapid cooling effects of these contact members.

In the example shown in FIG. 3, ribs 120A which are inclined with respect to the conveyance direction W of sheet P are formed on guide member 120 that guides a toner image carrying surface of sheet P.

Roller 112B that touches the toner image carrying surface of sheet P at the immediate downstream side of the guide member 120 is made of metal as described before.

Though the sheet P touches roller 112B and is cooled rapidly after touching rib 120A of guide member 120 to be cooled, the portion of the sheet P cooled by the guide member 120 is made uniform because the rib 120A is inclined with respect to the conveyance direction W. Then, the sheet P touches roller 112B made of metal after guided by inclined rib 120A.

Therefore, uneven gloss is hardly caused on the surface of sheet P even when the sheet P is cooled rapidly by roller 112B.

Though prevention of uneven gloss by guide member 120 having inclined rib 120A has been described, a rib similar to the inclined rib 120A formed on guide member 120 is formed also on each of guide members 127, 130, 131 and 133.

Metallic guide member 128 that cools sheet P rapidly is arranged at the downstream side of guide member 127, metallic guide member 135 that cools sheet P rapidly is arranged at the downstream side of guide members 131 and 133, and metallic roller 119B that cools sheet P rapidly is arranged at the downstream side of guide member 130.

By forming an inclined rib that is similar to rib 120A formed on guide member 120 even on each of guide members 127, 130, 131 and 133, it is possible to prevent sufficiently uneven gloss from being formed on the surface of the sheet, even when a contact member that cools sheet P rapidly is arranged at the downstream side of each of the guide members.

In the invention, cooling of a sheet carrying a toner image that contains wax is made uniform because a guide member on which a rib inclined with respect to the conveyance direction for the sheet is provided on a conveyance section.

Therefore, occurrence of uneven gloss can be prevented sufficiently even when a toner image is cooled rapidly by a contact member arranged at the downstream side of a guide member.

What is claimed is:

1. An image forming apparatus comprising:
an image forming section which forms a toner image on a sheet;
a fixing unit which heats and fixes the toner image on the sheet; and
a conveyance section which conveys the sheet which has passed through the fixing unit in a sheet conveyance direction,
wherein the conveyance section comprises:
a contact member which touches the sheet; and
a guide member which is positioned upstream of the contact member in the sheet conveyance direction and which guides the sheet being conveyed, and
wherein the guide member includes ribs which are inclined with respect to the sheet conveyance direction.

2. The image forming apparatus of claim 1,
wherein the contact member is made of metal.

3. The image forming apparatus of claim 1,
wherein the contact member is a second guide member which guides the sheet being conveyed.

4. The image forming apparatus of claim 1,
wherein the contact member is a conveyance roller.

5. The image forming apparatus of claim 1, wherein the ribs are positioned symmetrically with respect to a center line of a sheet conveyance path.

6. The image forming apparatus of claim 1,
wherein the conveyance section is a reversed sheet ejecting section which reverses the sheet upside down and ejects the reversed sheet.

7. The image forming apparatus of claim 1,
wherein the conveyance section is a sheet refeeding section which refeeds the sheet to the image forming section.

8. The image forming apparatus of claim 1,
wherein the contact member is a part of a curl correcting mechanism.
